(19) United States
(12) Patent Application Publication
(10) Pub. No.: US 2019/0000709 A1
(43) Pub. Date: Jan. 3, 2019

(54) MASSAGE MACHINE

(71) Applicant: DAITO ELECTRIC MACHINE INDUSTRY COMPANY LIMITED, Higashi-Osaka-shi, Osaka (JP)

(72) Inventors: Yasushi SONE, Higashi-Osaka-shi, Osaka (JP); Xiao Bin FENG, Higashi-Osaka-shi, Osaka (JP); Shinsaku SHIMIZU, Higashi-Osaka-shi, Osaka (JP)

(73) Assignee: DAITO ELECTRIC MACHINE INDUSTRY COMPANY LIMITED, Higashi-Osaka-shi, Osaka (JP)

(21) Appl. No.: 15/576,629

(22) PCT Filed: Jan. 17, 2017
(86) PCT No.: PCT/JP2017/001382

§ 371 Date: Nov. 22, 2017

(30) Foreign Application Priority Data
Oct. 20, 2016 (JP) 2016-206037

(51) Int. Cl. A61H 7/00

(52) U.S. Cl. CPC A61H 7/007; A61H 2201/0149; A61H 2201/1633; A61H 2203/0431; A61H 2201/1215; A61H 2201/1669; A61H 2201/1676; A61H 2205/10; A61H 2205/12; A61H 2205/086

(57) ABSTRACT

In the case of adopting a massage mechanism which is capable of mechanically treating a treatment region ranging from buttocks to thighs, it is ensured to prevent a user from feeling a discomfort feeling at a time of seating on a seat. A massage machine includes a seat massage mechanism which is provided inside a seat and performs a massage of a treatment region ranging from buttocks to thighs (treatment region including at least buttocks) of a user seating on the seat, and in this massage machine, a guide is arranged along a front and rear direction inside the seat allowing the seat massage mechanism to be movable in the front and rear direction.

### TECHNICAL FIELD

The present invention relates to a massage machine provided with a seat massage mechanism performing a massage of a treatment region ranging from buttocks to thighs of a user seating on the seat.

### BACKGROUND ART

Conventionally, as a massage machine performing a massage of a treatment region of buttocks of a user seating on the seat using a mechanical massage mechanism, there has been known such as Patent Literature 1.

A massage machine of Patent Literature 1 is formed in a bucket seat type such that a backrest part and a seat are integrated, and by guiding a massage mechanism along a rack part provided over a wide range from an upper end of the backrest part to a front end of the seat, a treatment for a wide range from shoulders to buttocks is made possible. That is, in the massage machine of Patent Literature 1, by moving the massage mechanism to a lower side of the seat, it becomes possible to perform a mechanical massage for a treatment region of buttocks.

### CITATION LIST

### Patent Literature

Patent Literature 1: Japanese Unexamined Patent Application Publication No. 2014-171

### SUMMARY OF THE INVENTION

### Technical Problem

By the way, in the massage machine of Patent Literature 1, the rack part for guiding the massage mechanism is installed immediately beneath a seat surface so as to be able to treat the buttocks. In the case where the rack part is installed in a position near the seat surface in this way, when a user seats on the seat surface, the buttocks of the user sink into the seat and abut to the massage mechanism and discomfort usage feelings such as pain or foreign body sensation may be possibly given to the user.

In particular, in the case where it is used as a chair-type massage machine, it may be also used by a user for the purpose of merely sitting thereon like a reclining chair, and it is preferable to adopt a structure so as to possibly prevent from giving discomfort feelings to the user when seating on the seat.

The present invention has been made in consideration of the above problem, and an object thereof is to provide a massage machine which is possibly capable of reducing the discomfort feelings felt by a user when seating on the seat by storing the massage mechanism in a position separated from the seat surface while adopting a massage mechanism which is capable of performing a mechanical treatment of a treatment region from buttocks to thighs (treatment region including at least buttocks).

### Solution to Problem

In order to solve the problem mentioned above, the massage machine of the present invention has taken the following technical measures.

That is, the massage machine of the present invention includes a seat massage mechanism that is provided inside a seat for performing a massage of a treatment region including at least buttocks of a user seating on the seat, and in this configuration, guide means is arranged along a front and rear direction inside the seat, thereby allowing the seat massage mechanism to be movable in the front and rear direction.

More preferably, the guide means is arranged so as to ride on both of a massage area where the treatment of the treatment region by the seat massage mechanism becomes possible and a storage area where the seat massage mechanism is allowed to be stored in a lower side of the seat.

More preferably, the guide means includes: a first guide rail disposed along the front and rear direction; and a first guide body that is provided on the other end side in the front and rear direction of a substrate body configuring the seat massage mechanism and moves while being in engagement with the first guide rail to thereby guide the substrate body in the front and rear direction, and in this configuration, an intermediate portion and the other end side of the first guide rail in the front and rear direction are extending substantially in a horizontal direction while one end side of the first guide rail in the front and rear direction is extended in a downward inclined state, and a boundary of the one end side and the other end side is made as an inflection position of an upward protruded shape, and the one end side of the first guide rail located in a region of the one end side from the inflection position corresponds to the storage area and the other end side of the first guide rail located in a region of the other end side from the inflection position corresponds to the massage area.

More preferably, the guide means includes: a second guide rail disposed above the first guide rail and disposed along the front and rear direction; and a second guide body that moves while being in engagement with the second guide rail to thereby guide the substrate body in the front and rear direction.

More preferably, the second guide body is located in the one end side with respect to the first guide body, and in this configuration, the first guide body is allowed to rotationally drive, and the first guide and the second guide body are located in a positional relationship such that, upon the second guide body arriving at the one end side of the second guide rail, the first guide body arrives at the inflection position of the first guide rail.

More preferably, the first guide rail is formed so that the rearward from the inflection position is made substantially parallel to the second guide rail.

More preferably, the seat massage mechanism is configured so as to move a massage body in the front and rear direction without following a posture change in the case where the first guide body is positioned at the other end side of the first guide rail.

More preferably, the seat massage mechanism is configured to swing the substrate body so that the rear part of the substrate body moves down about the second guide body arriving at the one end side of the second guide rail as a pivot in the case where the first guide body is positioned at the one end side of the first guide rail.

More preferably, the seat massage mechanism includes: a drive part for generating a rotational drive force; a rotating shaft that is rotationally driven by the rotational drive force generated by the drive part; a massage body that swings in the left and right direction by converting the rotational drive force of the rotating shaft; and a substrate body for mounting the drive part, the rotating shaft, and the massage body thereon, and damper means is provided between the massage body and the substrate body.

More preferably, the massage body includes: a massage arm that swings in the left and right direction by the rotational drive force of the rotating shaft; and a treatment piece provided at a tip end of the massage arm, and two or more treatment pieces are provided in parallel at the tip end of the massage arm.

More preferably, a foot massage mechanism is provided in a front side of the seat for performing a massage of a leg of a user by holding the leg, and in this configuration, the foot massage mechanism is configured so as to perform a stretch massage to a treatment region by moving the seat massage mechanism in the front and rear direction while the leg is held and fixed by the foot massage mechanism.

More preferably, a backrest part is provided on the rear side of the seat and a back massage mechanism is provided inside the backrest part for performing a massage of a back of a user, and in this configuration, while the seat massage mechanism is moved rearward and the user is kept in a state of being lifted up, the back massage mechanism is operated in the state of lifting up the user.

More preferably, the seat massage mechanism is configured to be moved to the storage area upon receipt of a massage stop command inputted by a user.

### Advantageous Effects of the Invention

According to the massage machine of the present invention, while adopting a massage mechanism which is capable of mechanically treating a treatment region from buttocks to thighs (treatment region including at least buttocks), by storing the massage mechanism in a position separated from a seat surface, it becomes possible to reduce a user's discomfort feeling as much as possible at a time of seating on a seat.

### BRIEF DESCRIPTION OF DRAWINGS

FIG. 1 is a perspective view showing a massage machine of the present embodiment.

FIG. 2 is a diagram showing only a seat massage mechanism of the present embodiment.

FIG. 3 is a side sectional view of the seat massage mechanism of the present embodiment.

FIG. 4 is a perspective view showing a case where the seat massage mechanism is positioned in a massage area in a rear side of the seat.

FIG. 5 is a side view showing a case where the seat massage mechanism is positioned in the massage area in the rear side of the seat.

FIG. 6 is a side view showing a case where the seat massage mechanism is positioned in the massage area (inflection position) in a front side of the seat.

FIG. 7 is a side view showing a case where the seat massage mechanism is positioned in a storage area in the front side of the seat.

FIG. 8 is a diagram showing a drive mechanism of a massage body of the seat massage mechanism.

### DESCRIPTION OF EMBODIMENTS

The following describes in detail an embodiment of a massage machine 1 of the present invention based on the drawings.

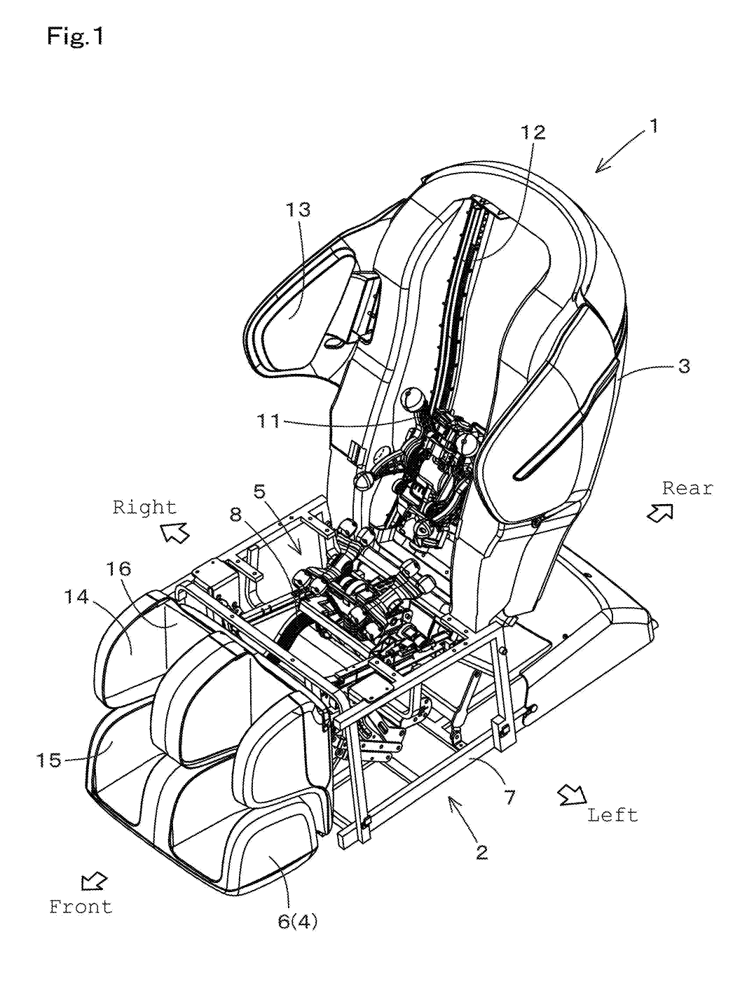

As shown in FIG. 1, the massage machine 1 of the present embodiment includes: a seat 2 having an area fully to support buttocks of a user from a lower side; a backrest part 3 provided on a rear side of this seat 2; and a footrest part 4 provided in a front side of the seat 2. Inside of the seat 2 mentioned above, there is provided a seat massage mechanism 5 for performing a massage of a treatment region from buttocks to lower limbs of a user (simply referred to as “treatment region”, hereinafter). Further, in the footrest part 4 in the front of the seat 2, there is provided a foot massage mechanism 6 formed in a shape into which the lower limbs of the user can be inserted and allowing a massage using an airbag for the lower limbs of the user.

The following describes the seat 2, backrest part 3, and footrest part 4, configuring the massage machine 1 of the present embodiment.

Note that, in the following description of the massage machine 1, as shown in FIG. 1, a height direction of the backrest part 3 of the chair-type massage machine in a standing state is defined as an upper and lower direction, and the explanation is made with definition of a left and right direction and a front and rear direction determined based on this upper and lower direction. These directions correspond to an upper and lower direction, left and right direction, and front and rear direction when viewed from a user seating on the massage machine 1. In order to clarify a relationship between the directions in the drawings and the directions in the actual apparatus, the left and right direction (width direction) and the front and rear direction used in the description of the present embodiment are designated in the representative drawings.

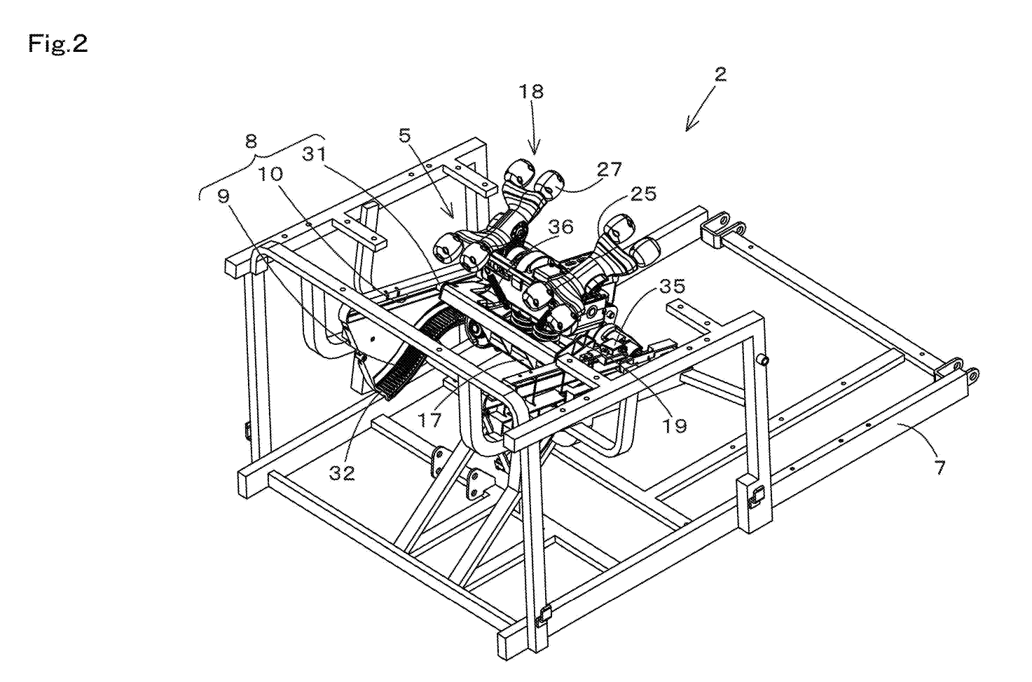

As shown in FIG. 2, the seat 2 includes a support frame 7 assembled by a combination of square bar shaped members. Inside this support frame 7, guide means 8 is arranged for making the seat massage mechanism 5 movable in the front and rear direction. This guide means 8 includes guide rails (a first guide rail 9 and a second guide rail 10 to be described later) arranged along the front and rear direction and makes the seat massage mechanism 5 movable in the front and rear direction along the guide rails. Note that, although illustration is omitted, on the upper part of the support frame 7 mentioned above, there is provided a cushion member which is used when a user seats, and the seat massage mechanism 5 and the guide means 8 are covered by a casing and the like, thereby blocking foreign matters and the like from entering from the outside.

As shown in FIG. 1, the backrest part 3 is a member positioned on the rearward of the seat 2 and it is configured so that a user can lean thereon. Inside the backrest 3, there are provided a back massage mechanism 11 performing a kneading, tapping, or grasping massage of a wide range from a shoulder region to a lumbar region through a back region of a user and a back rail 12 (back guide rail) which is capable of guiding this back massage mechanism 11 in the upper and lower direction. Further, the front side of the backrest part 3 is opened forward and a massage member for back massage can be protruded forward from the back massage mechanism 11. Moreover, on both left and right sides of the backrest part 3, there are provided upper arm massage parts 13 is provided so as to be protruded forward for allowing a pressure massage to be performed for the upper arms of the user using an air bag.

The footrest part 4 is disposed in the front of the seat 2 and a massage of lower limbs of a user is allowed to be performed by the foot massage mechanism 6 provided inside. In specific, the footrest part 4 includes a pair of upper foot massage bodies 14 and a pair of lower foot massage bodies 15 each of which is made movable in the upper and lower direction with respect to each of the upper foot massage bodies 14. In the pair of upper foot massage bodies 14 and the pair of lower foot massage bodies 15, concave parts 16 are formed in the left and right bodies, respectively, to which the lower limbs of the user can be inserted, and inside the respective concave parts 16, there are disposed air bags allowing a pressure massage of the lower limbs of the user, and it is configured to perform a massage by holding leg regions of the user using the upper and lower pairs of the airbags, respectively. That is, in the present embodiment, the foot massage mechanism 6 is configured of the upper and lower pairs of the airbags.

Further, although an illustration is omitted, beneath the seat 2, there are disposed a footrest swing mechanism for swinging the lower part of the footrest part 4 in a flip-up direction about the upper part of the footrest part 4 as a pivot and a compressor for supplying air to the airbags of the footrest part, and the like.

Next, the following describes the seat massage mechanism 5 and the guide means 8 for moving the seat massage mechanism 5 in the front and rear direction, which are specific features of the massage machine 1 of the present invention.

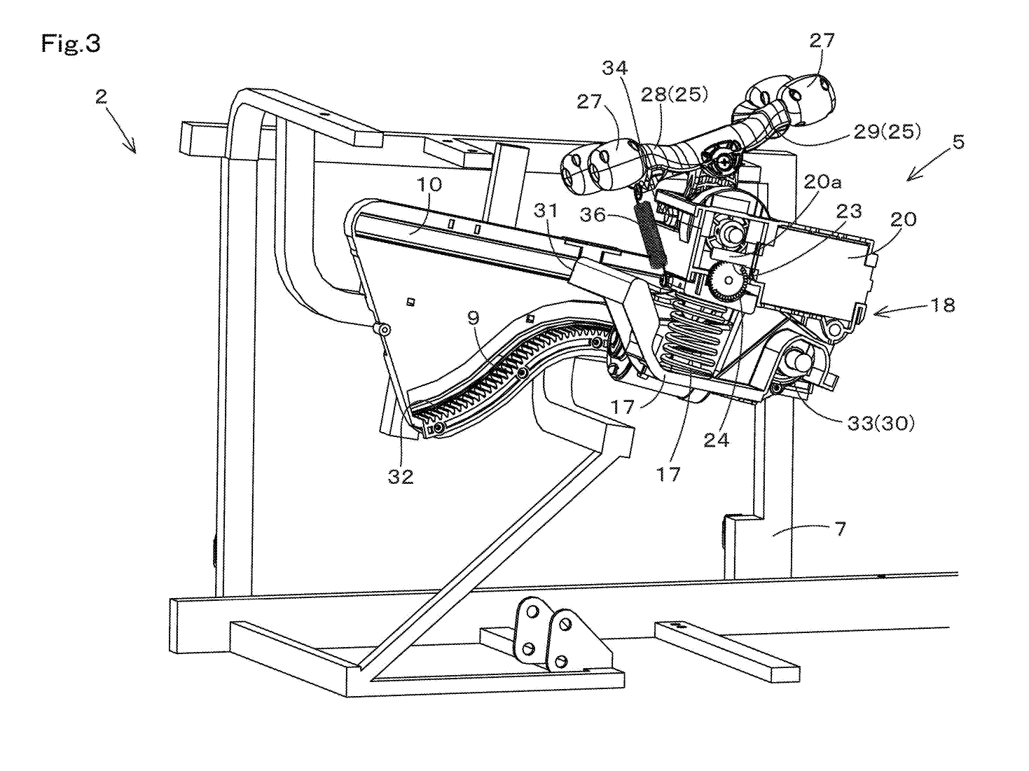

As shown in FIG. 3, the seat massage mechanism 5 includes: a substrate body 17 (base body) that is made movable by the guide means 8 (first guide rail 9 and second guide rail 10); a massage body 18 that is attached to this substrate body 17 and is made to be able to perform a massage of a treatment region of a user seated on the seat 2; and damper means 19 disposed between the substrate body 17 and the massage body 18.

Among the members composing the seat massage mechanism 5, the massage body 18 includes: a drive part 20 for generating a rotational driving force; a rotating shaft 21 that is rotationally driven by the rotational driving force generated by the drive part 20; and a massage member 22 (eccentric boss member) that swings in the left and right direction by converting the rotational driving force of the rotating shaft 21.

In specific, the drive part 20 composing the seat massage mechanism 5 of the present embodiment is composed of an electric motor disposed so that a drive shaft 20a is oriented rearward and slightly upward. On the upper side of the drive shaft 20a of this drive part 20, the rotating shaft 21 mentioned above is disposed in an intersection state. A worm gear 23 and a worm wheel 24 are provided between this drive shaft 20a and the rotating shaft 21, and the rotational driving force generated by the drive part 20 (electric motor) is made to be transmittable to the rotating shaft 21 while decelerating the rotational driving force.

On the rotating shaft 21, there is mounted a massage member 22 that swings in the left and right direction using the rotational driving force of the rotating shaft 21. This massage member 22 includes: an eccentric boss member that accompanyingly rotates with the rotating shaft 21; a massage arm 25 that is formed on the outer peripheral surface of the eccentric boss member and has its base end side slidably fitted into an inclined cam surface circulating around an axis center inclined with respect to the axis center of the rotating shaft 21; and a regulation part 26 (a regulation groove formed in the substrate body 17 and a regulation pin 34 movably fitted into this regulation groove in the left and right direction) for regulating the accompanying rotation of the massage arm 25 with the eccentric boss member. A treatment piece 27 is disposed on the tip of this massage arm 25 for contacting with a treatment region to perform a treatment.

Regarding the treatment piece 27 mentioned above, two or more thereof are provided in parallel on the tip of the massage arm 25. In specific, the massage body 18 of the present embodiment includes a front arm body 28 extending in the front side of the rotating shaft 21 and a rear arm body 29 extending in the rear side of the rotating shaft 21, and on each of the tips of the front arm body 28 and the rear arm body 29, two treatment pieces 27 in pairs are disposed in parallel in the left and right direction. By providing two or more treatment pieces 27 in parallel on the tip of the massage arm 25 in this way, it becomes possible to contact the treatment pieces 27 to a wide range in the left and right direction on the seat 2 and it becomes possible to perform a treatment from a left end to a right end of buttocks without any remaining.

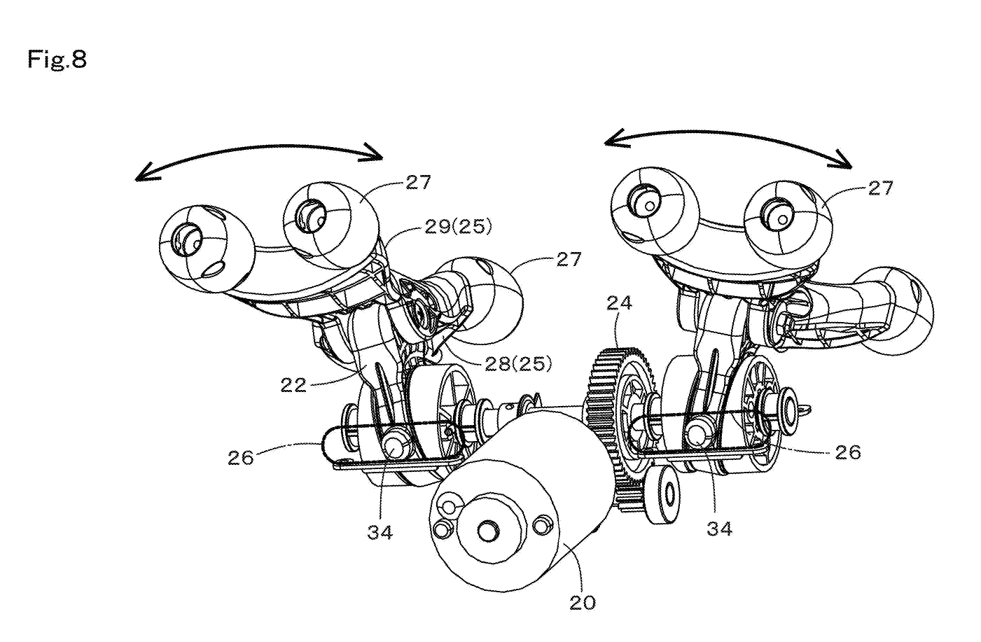

Note that, the seat massage mechanism 5 provided in the massage machine 1 of the present embodiment is configured to perform a kneading massage of a treatment region as shown in FIG. 8 and the like. However, as the seat massage mechanism 5 provided in the massage machine 1 of the present embodiment, not only ones performing a kneading massage but also ones performing a tapping massage, grasping massage or performing combinations of massages such as a kneading massage, tapping massage, and grasping massage can be used.

Among the members composing the seat massage mechanism 5, the substrate body 17 is made to be movable in the front and rear direction by the guide means 8 mentioned above and it is made to be able to mount the massage body 18 (in other words, the drive part 20, the rotating shaft 21, and the massage member 22). The middle of the substrate body 17 is formed in a concave shape recessed downward and damper means 19 is provided in the concave portion in the middle.

The damper means 19 mentioned above is provided in order to attenuate an impact so that the impact is not directly applied to the massage body 18 when a user seats on the seat 2. In specific, this damper means 19 is composed of left and right two coil springs disposed between the massage body 18 (in specific, a lower surface of a case body in which the worm gear 23 and the worm wheel 24 are stored) and the substrate body 17, and it is configured so that an impact applied from an upper position is mitigated by contracting the coil springs to thereby protect the massage body 18 and the guide means 8 from the impact.

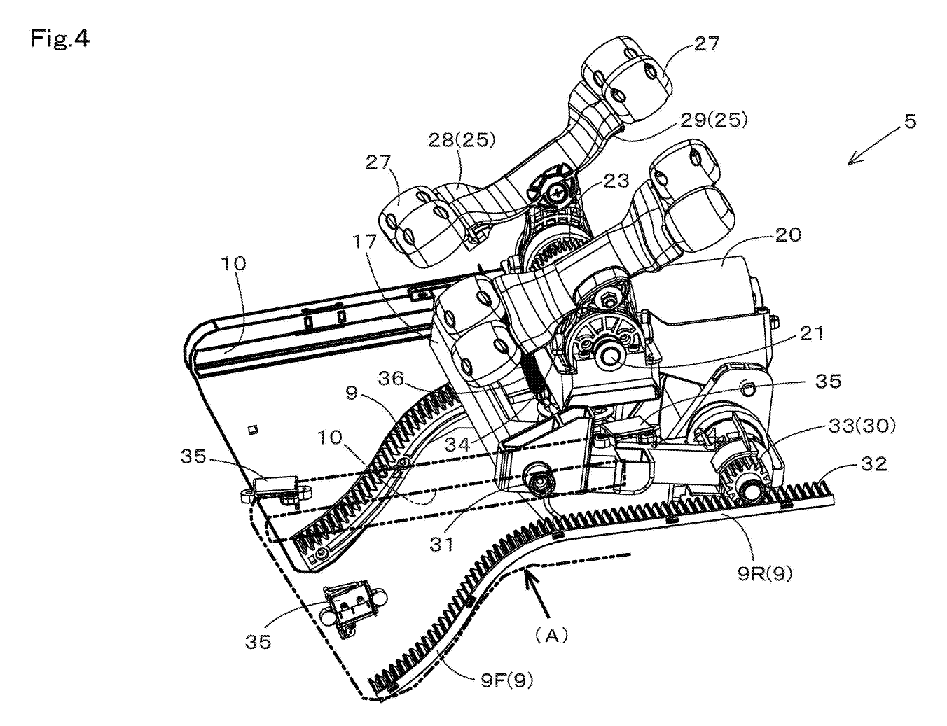

As shown in FIG. 4, the guide means 8 is intended to move the seat massage mechanism 5 mentioned above in the front and rear direction, and it includes two guide rails disposed along the front and rear direction and two guide bodies provided on the seat massage mechanism 5 and guided along these guide rails in the present embodiment.

Among these two guide rails, lower positioning one is the first guide rail 9 and upper positioning one is the second guide rail 10. Further, the first guide body 30 is configured to guide the substrate body 17 (seat massage mechanism 5) in the front and rear direction by moving while it is in engagement with the first guide rail 9. Furthermore, the second guide body 31 is configured to guide the substrate body 17 in the front and rear direction by moving while it is in engagement with the second guide rail 10.

The first guide rail 9 is configured to be able to guide the first guide body 30 of the substrate body 17 and it is formed so that the inclination directions of the front end portion 9F and the rear end portion 9R are different. That is, the rear end side 9R of the first guide rail 9 is substantially horizontally extended and the front end side 9F of the first guide rail 9 is forward extended in a downward inclined shape, and a boundary between the front end portion 9F and the rear end portion 9R is defined as an inflection position of an upward protruded shape.

Further, the front end of the first guide rail 9 is positioned in the rear side with respect to the front end of the seat 2 and the first guide rail 9 is prevented from forward jumping out from the seat 2 to thereby avoid the first guide rail 9 from positionally interfering with the footrest part 4,

Furthermore, the first guide rail 9 is arranged substantially in a middle position in the upper and lower direction inside the seat 2 and it is disposed in each of the both left and right sides inside the seat 2, and the left and right first guide rails 9 are formed at the same level in height each other, and thus the substrate body 17 can be horizontally held.

Each of the left and right first guide rails 9 has a plurality of rack teeth 32 protruded upward arranged in the front and rear direction and the first guide body 30 is engaged with these rack teeth 32, thereby allowing the substrate body 17 to move in the front and rear direction.

The first guide body 30 includes a traveling gear 33 provided in the rear side of the substrate body 17 of the seat massage mechanism 5. This traveling gear 33 is provided one by one in each of the left and right sides corresponding to the left and right first guide rails 9. This traveling gear 33 is a gear member capable of engaging (meshing) with the rack teeth 32 of the first guide body 30 mentioned above, and it is rotationally driven with its rotating direction switchable using such as a motor although not shown. That is, in the case where the first guide body 30 is rotationally driven in one direction, the first guide body 30 advances while engaging with the first guide rail 9, and in the case where the first guide body 30 is rotationally driven in the other direction, the first guide body 30 retreats while engaging with the first guide rail 9.

The second guide rail 10 is capable of guiding the second guide body 31 of the substrate body 17 and it is formed in a straight line shape forward and slightly upward from the rearward, which is different from the first guide rail 9. Further, the second guide rail 10 is formed as a groove capable of guiding the second guide body 31 in a slidable manner, but it does not include a rack tooth inside the groove.

The second guide rail 10 is arranged in a substantially upper position in the upper and lower direction inside the seat 2 and it is disposed in each of the both left and right sides inside the seat 2.

The length of the second guide rail 10 is formed to be shorter than that of the first guide rail 9. In specific, the length from the rear end to the front end of the second guide rail 10 is formed to be substantially equal to a distance from the rear end to the inflection position A in the first guide rail 9. Further, the second guide rail 10 is arranged so that the tip of the second guide rail 10 is located in a position protruded forward from the tip of the first guide rail 9.

Therefore, when the first guide body 30 moves to the inflection position A from the rear end of the first guide rail 9, the second guide body 31 moves to the front end from the rear end of the second guide rail 10 and the second guide body 31 abuts to the front end of the second guide rail 10 and becomes impossible to move forward any more. That is, the first guide rail 9 positioning in the front side of the inflection position A is formed to trace an arcuate locus about the front end of the second guide rail 10 as a pivot, and it is configured that, by guiding the first guide body 30 along the first guide rail 9 tracing the arcuate locus, the guide means 8 causes the substrate body 17 (the seat massage mechanism 5) to swing about the front end of the second guide rail 10 (the second guide body 31) as a pivot so that the rear part of the substrate body 17 falls down.

The second guide body 31 is provided on the front end side of the substrate body 17 and is made movable along the second guide rail 10. In specific, the second guide body 31 is a boss member protruded toward the both left and right sides from the substrate body 17 and it can be fitted into the second guide rail 10 formed in a groove shape. That is, since the second guide rail 10 is configured so as not to change the height in the upper and lower direction so much compared to the first guide rail 9 as mentioned above, at the time of moving the substrate body 17 in the front and rear direction, the substrate body 17 results in moving in the front and rear direction without changing the height of the front end while the second guide body 31 is being fitted into the second guide rail 10.

As indicated by “A” in FIG. 4, the inflection position A of the first guide rail is positioned slightly closer to the front end from the intermediate with respect to the intermediate in the front and rear direction and it is a curved portion so as to be an upward protruded shape. The front side from the inflection position A where this first guide rail 9 inflects corresponds to the “storage area” and in the case where the first guide body 30 mentioned above exists in the front side from the inflection position A, it is referred to as “the seat massage mechanism 5 exists in the storage area”. Further, the rear side from the inflection position A corresponds to the “massage area” and in the case where the first guide body 30 mentioned above exists in the rear side from the inflection position A, it is referred to as “the seat massage mechanism 5 exists in the massage area”. That is, the guide means 8 mentioned above is disposed so as to ride over both of the massage area and the storage area.

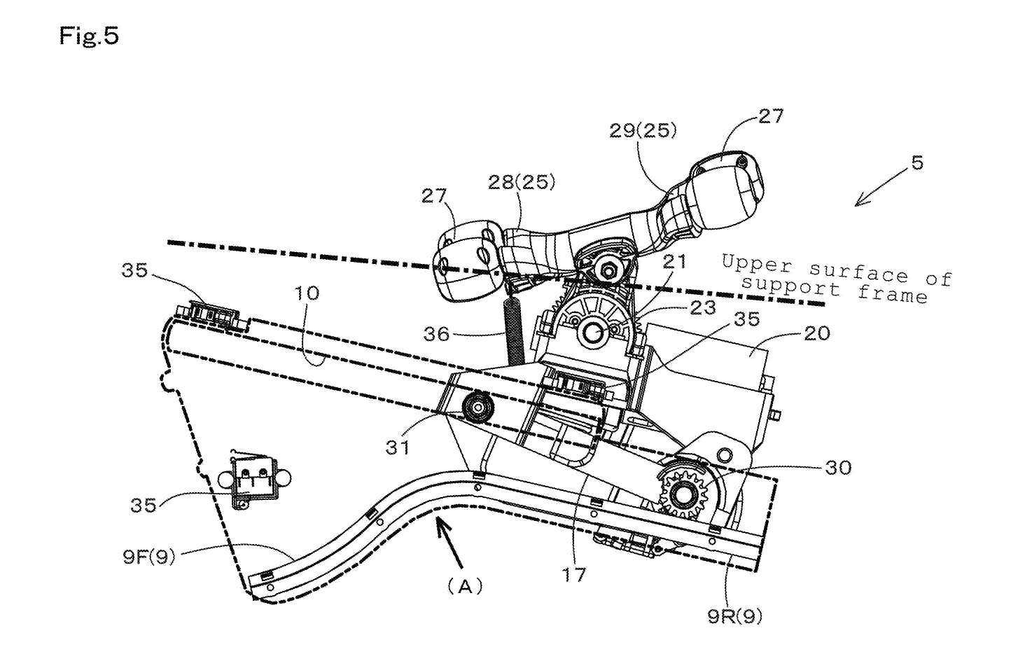

Next, the following describes how the posture of the seat massage mechanism 5 changes in the case where “the seat massage mechanism 5 (substrate body 17) exists in the storage area” and in the case where “the seat massage mechanism 5 (substrate body 17) exists in the massage area”, with reference to FIGS. 5 to 7.

As shown in FIG. 5, in the case where “the seat massage mechanism 5 exists in the massage area”, the second guide body 31 is fitted into the second guide rail 10 and the first guide body 30 is engaged with the rack teeth 32 formed on the rear end side of the first guide rail 9. In this state, since the tip of the massage body 18, more specifically, the treatment piece 27 of the front arm body 28 and the treatment piece 27 of the rear arm body 29 are both protruded upward from the upper surface of the support frame 7, the distance from each of the treatment pieces 27 to a treatment region becomes closer and the mechanical massage by the treatment pieces 27 to the treatment region (buttocks of a user) can be effectively performed.

Further, in the case where the first guide body 30 is rotationally driven, the first guide body 30 is engaged with the rack teeth 32 of the first guide rail 9 and the second guide body 31 advances while being fitted into the second guide rail 10. At this time, since the rear end side of the first guide rail 9 and the second guide rail 10 are formed substantially in parallel, the seat massage mechanism 5 moves forward without changing the posture. Therefore, in the case where “the seat massage mechanism 5 exists in the massage area”, a massage to a treatment region can be effectively performed continuously.

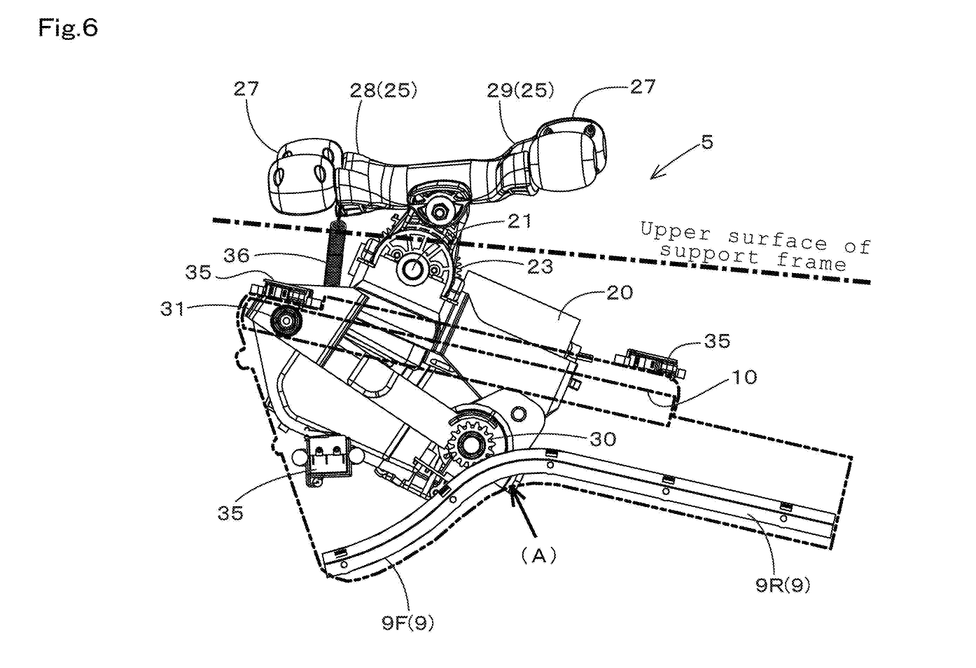

As shown in FIG. 6, when the first guide body 30 then arrives at the inflection position A of the first guide rail 9, the second guide body 31 also arrives at the front end of the second guide rail 10 and the second guide body 31 cannot move forward any more. On the other hand, since the first guide rail 9F in the front side from the inflection position A is formed to trace an arcuate locus about the front end of the second guide rail 10 as a pivot, in the case where the first guide body 30 is guided further forward from the inflection position A, the substrate body 17 (seat massage mechanism 5) becomes to swing about the front end (second guide body 31) of the second guide rail 10 as a pivot so that the rear part of the substrate body 17 falls down.

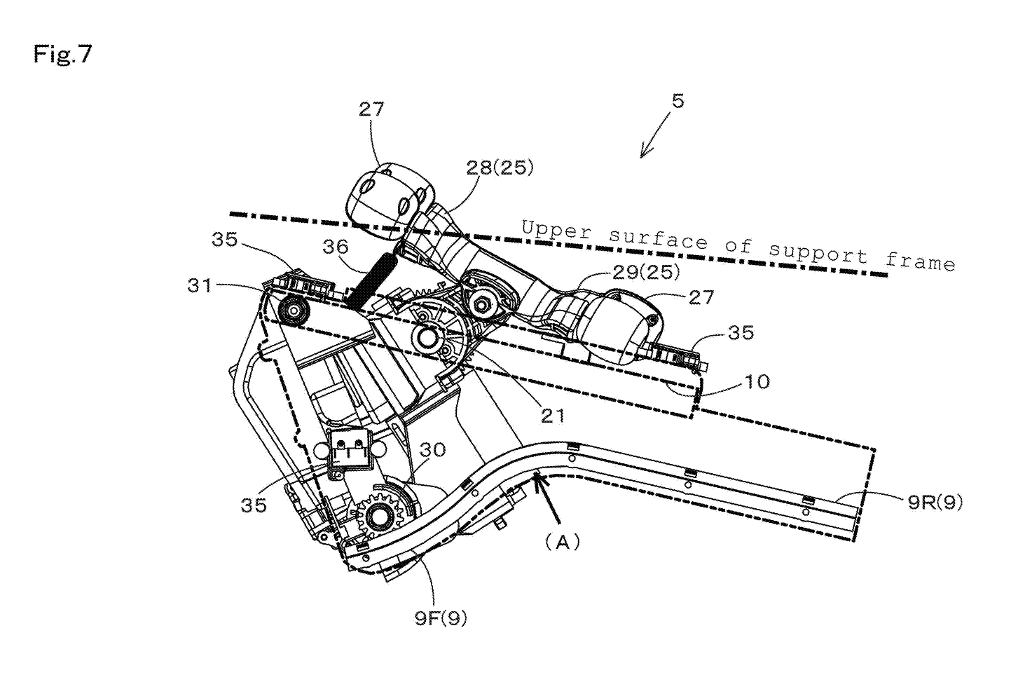

As shown in FIG. 7, in the case where “the seat massage mechanism 5 exists in the storage area”, the position of the second guide body 31 does not change from the position of FIG. 6 (front end of the second guide rail 10). However, the first guide body 30 is guided to the front end side 9F of the first guide rail 9 which traces an arcuate locus about the front end of the second guide rail 10 as a pivot. As a result, the substrate body 17 (seat massage mechanism 5) swings about the front end (second guide body 31) of the second guide rail 10 as a pivot so that the rear portion of the substrate body 17 falls down and the posture of the seat massage mechanism 5 becomes to be inclined.

In the state that the posture of the seat massage mechanism 5 is inclined in this way, of the two treatment pieces, the treatment piece 27 of the front arm body 28 and the treatment piece 27 of the rear arm body 29, although the front side treatment piece 27 is protruded upward from the upper surface of the support frame 7, the rear side treatment piece 27 falls downward from the upper surface of the support frame 7, and therefore the distance from the treatment piece 27 to a treatment region increases. That is, in the case where “the seat massage mechanism 5 exists in the storage area”, since the seat massage mechanism 5 is stored in a position separated from the seat surface, an impact from the treatment piece 27 is suppressed from applying and giving discomfort feelings to a user when seating on the seat.

As a result, in the massage machine of the present embodiment, while adopting the massage mechanism 1 capable of mechanically treating a treatment region from buttocks to thighs (treatment region including at least buttocks), the massage mechanism 1 can be stored in the position separated from the seat surface and the discomfort feelings given to a user when the user seats on the seat can be possibly reduced.

By the way, as described above, the seat massage mechanism 5 can effectively perform a massage from buttocks to rear sides of thighs of a user seating on the seat 2, and when storing the seat massage mechanism 5 that is positioned in the storage area, since the seat massage mechanism 5 sinks down, it is prevented that a user feels the existence thereof.

The seat massage mechanism 5 revealing such remarkable actions and effects can also perform a further effective massage.

For example, legs (lower limbs) of a user are held and fixed by the foot massage mechanism 6 described above. By doing like this, the legs (lower limbs) of the user can be fixed by the foot massage mechanism 6. And while the legs (lower limbs) of the user are fixed by the foot massage mechanism 6, the seat massage mechanism 5 is reciprocally moved in the front and rear direction by the guide means 8 and a massage of the treatment region is performed by the seat massage mechanism 5. By doing like this, the region from buttocks to thighs can be stretched so as to be extended by the treatment pieces 27 and a stretch massage can be performed from the buttocks to the thighs.

Further, as shown in FIG. 5, the seat massage mechanism 5 is moved to a back of the seat 2. At this time, since the rear arm body 29 appears to rise upward than the front arm body 28 by a tension spring 36 (a spring connecting the substrate body 17 side and the tip of the front arm body 28), the user seating on the seat 2 can be kept in a lifted-up state. While remaining in this state, a back massage mechanism 37 is operated. By doing like this, even in the case where a back rail 12 cannot be fully extended to a lower side, a massage by the back massage mechanism 5 can be effectively applied to a lumber region of the user.

By the way, in the case of the present embodiment, there is provided a position recognition member (limit switch 35) in order to recognize the seat massage mechanism 5. In specific, as shown in FIGS. 5 to 7, the limit switch 35 has been provided on a movement path of the first guide body 30 in the first guide rail 9 or on a movement path of the second guide body 31 in the second guide rail 10 to thereby recognize a position or state of the back massage mechanism 5 by the limit switch 35.

For example, in the present embodiment, one limit switch 35 is provided in each of the rear end side and front end side of the second guide rail 10 and one limit switch 35 is provided in the front end side of the first guide rail 9, thus total three limit switches 35 are provided. By providing the limit switches 35 like this, it is possible to determine based on signals from the respective limit switches 35 in which position of the “massage area”, “storage area” or intermediate position of the both areas, the seat massage mechanism 5 is positioned. The limit switch 35 may be provided on the inflection position A of the first guide rail 9 in order to exactly recognize the intermediate position.

Further, in the case where the position of the seat massage mechanism 5 can be recognized, there can be adopted such an usage aspect that, the seat massage mechanism 5 is held in the storage area when a massage is not performed, in other words, when a user seats on the seat 2, and after the user seating on the seat 2 generates a command of a massage, the seat massage mechanism 5 is moved from the storage area to the massage area. By this arrangement, the user is prevented from feeling discomfort due to an impact caused by abutment to the seat massage mechanism 5 when seating on the seat 2.

Furthermore, when performing a massage, the seat massage mechanism 5 is allowed to reciprocate between the limit switches 35 of the rear end side and the front end side of the second guide rail 10, and a massage of a treatment region ranging from buttocks to thighs of a user can be mainly performed.

Regarding a massage operation shown as following, a cooperative movement of the seat massage mechanism 5, back massage mechanism 37 and foot massage mechanism 6 can be performed using a control part for controlling these mechanisms, a controller for commanding a massage operation of this control part, and the like.

Note that, the embodiments disclosed this time are exemplified in all viewpoints and should not be considered as restrictive ones. In particular, in the embodiment disclosed this time, items which are not explicitly disclosed, for example, a drive condition or an operating condition, various kinds of parameters, size, weight, and volume of components are not departing from a range normally carried out by those skilled in the art and values easily expected by those usually skilled in the art are adopted.

In the embodiment described above, the massage machine of the present invention was described listing an example that, the storage area of the seat massage mechanism 5 is provided in the front side of the seat 2 and the massage area of the seat massage mechanism 5 is provided in the rear side of the seat 2. However, the storage area of the seat massage mechanism 5 may be provided in the rear side of the seat 2 and the massage area of the seat massage mechanism 5 may be provided in the front side of the seat 2.

In other words, in the description of the present embodiment, although the description was made exemplifying a form that, the one ends of the first guide rail 9 and the second guide rail 10 are directed forward and the other ends are directed rearward, the first guide rail 9 and the second guide rail 10 may be disposed in the opposite direction along the front and rear direction. In this case, the form is that, the one ends of the first guide rail 9 and the second guide rail 10 are directed rearward and the other ends are directed forward.

Further, in the description of the present embodiment, although the rear ends (the other ends) of the first guide rail 9 and the second guide rail 10 are provided so as to be terminated at the rear end portion of the seat 2, these may be extended as they are and may be installed so as to be extended upward within the backrest part 3. By this arrangement, it becomes possible that the seat massage mechanism 5 may be moved within the backrest part 3 and may be used also as the back massage mechanism 11.

Further, in the description of the present embodiment, the description was made assuming that the seat massage mechanism 5 performs a “kneading massage”. However, the seat massage mechanism 5 may be added with other kinds of massages such as, for example, (a tapping massage). There may be adopted various mechanisms generating a massage.

### REFERENCE SIGNS LIST

1 Massage machine

2 Seat

3 Backrest part

4 Footrest part

5 Seat massage mechanism

6 Foot massage mechanism

7 Support frame

8 Guide means

9 First guide rail

9F Front end part of first guide rail

9R Rear end part of first guide rail

10 Second guide rail

11 Back massage mechanism

12 Back rail (back guide rail)

13 Upper arm massage part

14 Upper foot massage body

15 Lower foot massage body

16 Concave part

17 Substrate body (base body)

18 Massage body

19 Damper means

20 Drive part

20a Drive shaft of drive part

21 Rotating shaft

22 Massage member

23 Worm gear

24 Worm wheel

25 Massage arm

26 Regulation part (regulation groove)

27 Treatment piece

28 Front arm body

29 Rear arm body

30 First guide body

31 Second guide body

32 Rack teeth

33 Traveling gear

34 Regulation pin

35 Limit switch

36 Tension spring

A Inflection position

1. A massage machine comprising a seat massage mechanism that is provided inside a seat for performing a massage of a treatment region including at least buttocks of a user seating on the seat, wherein
a guide is arranged along a front and rear direction inside the seat, thereby allowing the seat massage mechanism to be movable in the front and rear direction.

2. The massage machine according to claim 1, wherein the guide is arranged so as to ride on both of a massage area where the treatment of the treatment region by the seat massage mechanism becomes possible and a storage area where the seat massage mechanism is allowed to be stored in a lower side of the seat.

3. The massage machine according to claim 2, wherein the guide comprises: a first guide rail disposed along the front and rear direction; and a first guide body that is provided on the other end side in the front and rear direction of a substrate body configuring the seat massage mechanism and moves while being in engagement with the first guide rail to thereby guide the substrate body in the front and rear direction, wherein
an intermediate portion and the other end side of the first guide rail in the front and rear direction are extending substantially in a horizontal direction while one end side of the first guide rail in the front and rear direction is extended in a downward inclined state, and a boundary of the one end side and the other end side is made as an inflection position of an upward protruded shape, and wherein
the one end side of the first guide rail located in a region of the one end side from the inflection position corresponds to the storage area and the other end side of the first guide rail located in a region of the other end side from the inflection position corresponds to the massage area.

4. The massage machine according to claim 3, wherein the guide comprises: a second guide rail disposed above the first guide rail and disposed along the front and rear direction; and a second guide body that moves while being in engagement with the second guide rail to thereby guide the substrate body in the front and rear direction.

5. The massage machine according to claim 3, wherein a second guide body is located in the one end side with respect to the first guide body, wherein
the first guide body is allowed to rotationally drive, and wherein
the first guide and the second guide body are located in a positional relationship such that, upon the second guide body arriving at the one end side of a second guide rail, the first guide body arrives at the inflection position of the first guide rail.

6. The massage machine according to claim 3, wherein the first guide rail is formed so that the rearward from the inflection position is made substantially parallel to a second guide rail.

7. The massage machine according to claim 6, wherein the seat massage mechanism is configured so as to move a massage body in the front and rear direction without following a posture change in the case where the first guide body is positioned at the other end side of the first guide rail.

8. The massage machine according to claim 7, wherein the seat massage mechanism is configured to swing the substrate body so that the rear part of the substrate body moves down about the second guide body arriving at the one end side of the second guide rail as a pivot in the case where the first guide body is positioned at the one end side of the first guide rail.

9. The massage machine according to claim 1, wherein the seat massage mechanism comprises: a drive part for generating a rotational drive force; a rotating shaft that is rotationally driven by the rotational drive force generated by the drive part; a massage body that swings in the left and right direction by converting the rotational drive force of the rotating shaft; and a substrate body for mounting the drive part, the rotating shaft, and the massage body thereon, and wherein
a damper is provided between the massage body and the substrate body.

10. The massage machine according to claim 9, wherein the massage body comprises: a massage arm that swings in the left and right direction by the rotational drive force of the rotating shaft; and a treatment piece provided at a tip end of the massage arm, and wherein
two or more treatment pieces are provided in parallel at the tip end of the massage arm.

11. The massage machine according to claim 1, wherein a foot massage mechanism is provided in a front side of the seat for performing a massage of a leg of a user by holding the leg, and wherein
the foot massage mechanism is configured so as to perform a stretch massage to a treatment region by moving the seat massage mechanism in the front and rear direction while the leg is held and fixed by the foot massage mechanism.

12. The massage machine according to claim 1, wherein a backrest part is provided on the rear side of the seat and a back massage mechanism is provided inside the backrest part for performing a massage of a back of a user, and wherein
while the seat massage mechanism is moved rearward and the user is kept in a state of being lifted up, the back massage mechanism is operated in the state of lifting up the user.

13. The massage machine according to claim 3, wherein the seat massage mechanism is configured to be moved to the storage area upon receipt of a massage stop command inputted by a user.
